(19) United States
(12) Patent Application Publication
(10) Pub. No.: US 2011/0119158 A1
(43) Pub. Date: May 19, 2011

(54) SYSTEM FOR INCREASING EFFICIENCIES IN DISTRIBUTION OF PRE-OWNED VEHICLES

(76) Inventor: Garry Gladstone, Incline Village, NV (US)

(21) Appl. No.: 12/620,378

(22) Filed: Nov. 17, 2009

(51) Int. Cl. G06Q 30/00; G06Q 50/00; G06Q 90/00; G06Q 20/00

(52) U.S. Cl. 705/27.1; 705/500

(57) ABSTRACT

A system and method for increasing efficiencies in the distribution and sales of pre-owned vehicles utilizing a communications network such as the internet. A purchase order agreement is made between a consumer and a dealer for purchase of one or more vehicles available for sale to dealers, viewed over the communications network. The sale is conditioned upon a selected vehicle first being acquired by the dealer subsequent to entry of the consumer and dealer into the purchase order agreement. The dealer acquires the selected vehicle through an auction limited to dealers. The system may be administered by an organization which is not itself a dealer or auction.

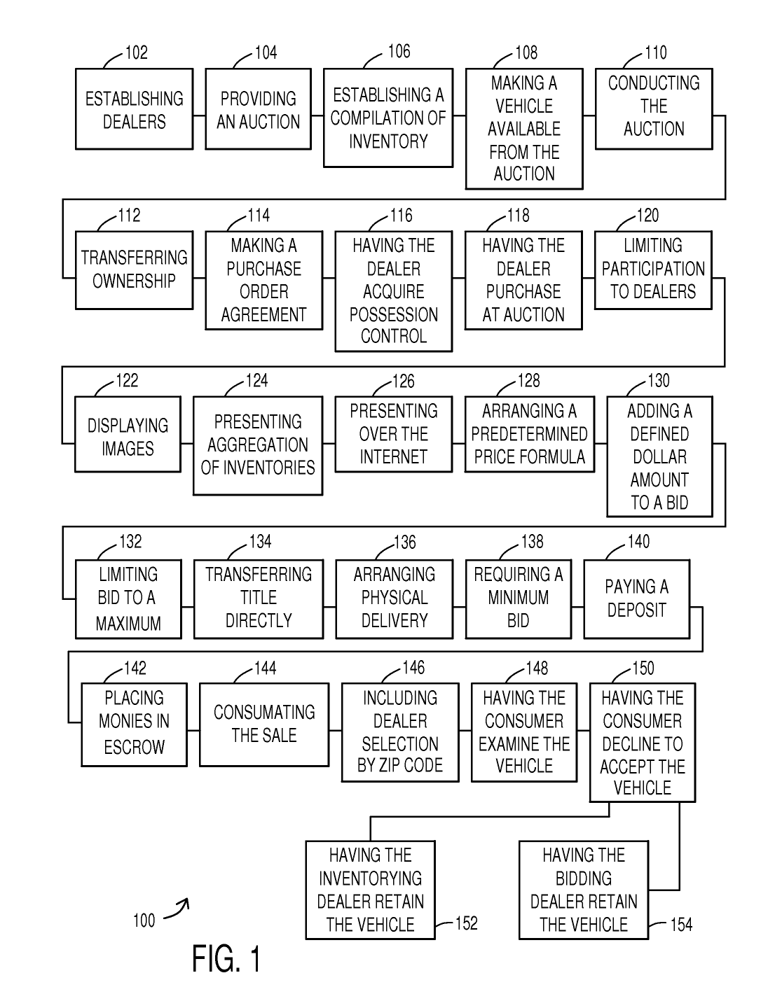

### FIELD OF THE INVENTION

This invention relates to the distribution, marketing, and sales of pre-owned vehicles.

### BACKGROUND OF THE INVENTION

Prior to the present invention, the distribution, marketing, and sales of pre-owned motorized and non-motorized vehicles and vessels (hereinafter also referred to as “vehicle” or “vehicles”) has been limited to primarily low technology, inefficient methods which create inherent detriments against the best interests of consumer purchasers.

Vehicles normally represent the single most expensive depreciating asset owned at any given time by the typical consumer. As a result, vehicle ownership represents one of largest expenses in the lifetime budget of the typical consumer. One of the significant factors in the high cost of vehicle ownership is the extraordinarily high transaction costs typically associated with the prior art methods of vehicle acquisition and divestiture. These costs include excessive amounts of money, time, pressure, and stress.

No other common, high necessity consumer goods are associated with higher percentage transaction costs (primarily the dealer markups) on such large average transaction sizes. A primary driver of these persistently high transaction costs is the continued reliance on the entrenched prior art methods of the distribution and sale of pre-owned vehicles

The main problem stems from the custom of the typical pre-owned vehicle dealer (hereinafter also referred to as “dealer” or “dealers”) purchasing sufficient inventory to fill their dealership display space, with vehicles the dealer unilaterally selects in the hope that those vehicles so selected by the dealer's mere best guess, will be the same vehicles that the interested prospects in the dealer's area will want to purchase from the dealer.

While that method of purchasing and displaying inventory for retail selling remains appropriate for the more fungible, un-used consumer staples such as those items sold in supermarkets, it is a grossly inefficient means for selling pre-owned vehicles. That is because each pre-owned vehicle represents a unique combination of year, make, model, mileage (or vessel hours), equipment, color and condition, and therefore, there always exists a high degree of uncertainty as to whether the inventory purchased and displayed by the dealer, will be the same inventory that can be profitably re-sold to consumers.

That high degree of inventory re-sale uncertainty inherent in the prior art, creates significant financial risks for dealers in the form of significant increases in all of the costs and expenses associated with acquiring and maintaining vehicles in inventory, including but not limited to: losses on unsold vehicles eventually liquidated at dealer auctions including the costs of transportation to the auction and auction fees, losses on retail sales of vehicles which have declined in value due to the simple passage of time or due to diminished demand based on extrinsic factors such as a general slowing of the economy, significant increases in the price of fuel, or negative reports in the news media regarding safety, reliability or the cost of repairs of any particular model(s) in inventory, costs of capital for the acquisition and carrying of the inventory, and expenses associated with displaying the inventory such as rent, interest, taxes, insurance, and maintenance.

The large financial risks posed to dealers as the result of inventory resale uncertainties inherent under the prior art, requires that dealers must add large mark-ups over their inventory acquisition costs in order to survive and earn a reasonable overall profit.

For consumers, those large mark-ups required under the prior art cause significant increases in many of the major costs of owning a vehicle including but not limited to: depreciation, interest, insurance, taxes and registration.

But those increased costs of ownership only represent one of the many detriments to consumers under the prior art. Additional detriments include: a) the time, energy and expense of searching the inventories of many different dealers and/or websites looking for a vehicle which fits the consumer's criteria; b) being steered, pushed, pressured and/or mislead into buying a vehicle which does not meet the desired criteria, by a dealer who is feeling the pressure of the need to sell the inventory that the dealer has already purchased, which is the root cause of the conflict of interest between the dealer and the consumer that makes the typical vehicle buying experience unpleasant and difficult; and c) enduring the test of wills which that conflict of interest creates by placing the dealer's need to sell those vehicles that happen to be in the dealer's inventory, at the highest possible mark-up to avoid and offset losses on inventory, in direct opposition to the best interests of the consumer who is typically seeking to find a vehicle that actually meets the consumer's desired selection criteria at the lowest possible price.

In recognition of the difficulties that some of those issues and limitations pose to the average consumer vehicle buyer, the prior art has been stretched to its limits in some excellent models which have succeeded in extracting the maximum efficiency available within the inherent limitations of the prior art. The most intelligent applications are from companies such as Car Max and Auto Nation. Their models seem to suggest that they had clearly seen the problems associated with limited inventories inherent in the prior art.

They attempt to address at least part of those limitations by utilizing unprecedented enormous amounts of display space and filling it with equally unprecedented enormous amounts inventory. Their scale is so massive that they may use golf carts to tour prospective buyers around their gigantic display lots to view their gigantic inventories. While those practitioners have provided excellent examples of how to somewhat mitigate the limitations inherent in the prior art, their models do not serve to significantly overcome or remove them.

Their model of massive inventories is limited by a variety of practical restraints including consumer resistance to long journeys on foot or in a golf cart to find the one vehicle in which they may be interested somewhere in the midst of a parking lot filled with hundreds of other vehicles, especially in conditions of excessive heat, cold and/or precipitation. In addition, there are practical limitations posed by the difficulties associated with adequate land availability and land use restrictions, especially within the most densely populated areas, which may as a result be located too far away from the nearest Car Max or Auto Nation to be conveniently served by them.

More importantly, the inherent conflict arising out of the need to sell the inventory that they have already purchased, which still may not include a vehicle that meets the consumer's desired selection criteria, augurs for pressure on the consumer to choose from something on display, to which the consumer may grudgingly succumb for the purpose of avoiding the alternative of spending any more time hunting for the truly desired vehicle.

Most importantly, the Car Max and Auto Nation massive inventory models do nothing to effectively address the prior art limitation inherent in the high costs associated with inventory acquisition, carrying costs, depreciation, display and maintenance, which are necessarily passed through in the form of higher prices to the detriment of consumers.

From the preceding descriptions, it is apparent that the methods currently being used have significant disadvantages. Thus, important aspects of the technology used in the field of invention remain amenable to useful refinement.

### SUMMARY OF THE INVENTION

With the recent advent of digitization of the listings of vehicles included in dealer-only private wholesale pre-owned vehicle auctions (hereinafter also referred to as “auctions”), including internet accessible descriptions and detailed condition reports complete with photographic images, the present invention is now feasible to be put into practice. The practice of the present invention carries with it, the potential to save consumers millions of dollars each year in transaction costs, and enable vehicle dealers to gain faster and more efficient inventory turnover, which may result in increased overall total profits to the dealers, even after passing some of the savings along to their customers in the form of substantially reduced per unit markups.

Similar to ordering a new car with all of the desired features and options conveniently selected from a listing in a catalogue or brochure, the practice of the present invention will enable consumer buyers of pre-owned vehicles to view the staggeringly vast number and wide variety of pre-owned vehicles that are regularly listed for sale across the nation, by dealer-only wholesale auto auction companies, either directly, or indirectly through their selected local dealer. Consumers may then select from such listings, and conveniently order the purchase of the desired pre-owned vehicle, by simply authorizing their selected dealer to buy the listed vehicle through the listing auction, for resale to the consumer buyer in fulfillment of the consumer buyer's purchase order.

The purpose of the present invention is to provide a means to increase efficiencies and thereby reduce the costs involved in the purchase and sale of pre-owned vehicles, creating significant savings for vehicle consumer purchasers and/or vehicle dealer sellers.

Another purpose of the present invention is to reduce the amount of time, energy, inconvenience, expense and frustration involved in searching the many disparate physical and electronic displays of pre-owned vehicles in search of one or more vehicles that meet the consumer's desired selection criteria.

Another purpose is to reduce and/or eliminate the conflicts of interest between vehicle dealers and vehicle consumers, which lead to unwelcome pressure, stress and difficulty.

The present invention introduces such refinement and accomplishes its intended purposes by the aggregation of vehicle inventory data from various dealer-only wholesale auto auctions, into a seamless means of viewing all such data together at one single source such as a Worldwide Web Page on the Internet, directly via the consumers own computers, and/or indirectly via the computer of a consumer's selected dealer; or alternatively, consumer viewing of a plurality of separate un-aggregated dealer-only wholesale auto auction web pages indirectly via a dealer's computer; with all of the foregoing for the purpose of consumer viewing of and/or access to all inventory currently available for sale at dealer wholesale prices at the various dealer-only auction auctions worldwide.

In its preferred embodiments, the present invention has several aspects or facets that can be used independently or together in any combination to optimize their benefits. All of the foregoing operational principles and advantages of the present invention will be more fully appreciated upon consideration of the following detailed description.

### BRIEF DESCRIPTION OF THE DRAWING

Various objects, features, and attendant advantages of the present invention will become more fully appreciated as the same becomes better understood when considered in conjunction with the accompanying drawing, which is a block diagram of steps of a method of practicing the invention. The diagram is read starting at the upper left and proceeding to the right and downwardly.

### DETAILED DESCRIPTION

The present invention sets forth a system of distribution, marketing, and sales of vehicles to the general public. It is contemplated that used or pre-owned automobiles and light trucks will be the principal beneficiaries of the novel system, although all other types of vehicles, such as motorcycles, boats, recreational vehicles, airplanes, trucks, heavy equipment, and others may be distributed, marketed and/or sold using the novel system.

The system comprises two types or groups of participants involved in the remarketing, sales and distribution of pre-owned vehicles (as opposed to the consumer retail purchasers). One type is a plurality of participating vehicle dealers who cater directly to consumer retail purchasers. The other type is a plurality of dealer-only wholesale vehicle auction companies who only serve vehicle dealers (and fleet, lease and finance companies) and exclude the public. Participating dealers may be restricted to dealers who have met specified criteria for being accepted as participating dealers, and who have formally been recognized as member participating dealers within the novel system.

Dealers and financial institutions having excess or unwanted vehicles, deliver such vehicles to wholesale auction companies, either physically or by representative data sent electronically, for wholesale sale by means of inclusion within the dealer-only wholesale vehicle auction company sales events and any other means by which such wholesale vehicle auction companies may facilitate wholesale vehicle sales exclusively to vehicle dealers. The dealer-only wholesale vehicle auction companies typically compile a list of all such vehicles, which is then distributed exclusively to dealers for the purpose of raising awareness and stimulating interest which will bring bids from dealers who are seeking to purchase inventory for resale. Such listing information may be made available in digital or other form which may be disseminated over communications networks. This information may include for example, year, make, model, mileage, color, condition, vehicle identification number, images of the vehicle, and/or any other descriptive information. The present invention teaches the step of then making this information available to the general public over a communications channel such as the internet.

The present invention also teaches the step of aggregating the lists compiled by the various dealer-only wholesale vehicle auction companies into a larger master listing which is made available to consumers to provide them with a more seamless and efficient means of finding their desired vehicle electronically. The master listing may of course be searchable by various criteria and/or subdivided as may be convenient, for example, to separate automobiles from light trucks, products of one manufacturer from those of another, or in any other way. Any such divisions should not be held to constitute separate listings.

The master listing may be viewed by consumers worldwide. For example, the master listing may be displayed on a website and accessed over the internet. This way a consumer may view available vehicles without travel, such as from his or her home.

An individual consumer may then select a particular vehicle. A consumer wishing to buy the selected vehicle may then select a participating dealer from a plurality of participating dealers who are ready, willing, and authorized to participate in the practice of this invention. The system may for example, show a listing of all participating dealers, or alternatively may make individual and/or small groups of participating dealers available to consumers by a search engine. For example, a consumer may enter a zip code, such as the zip code of his or her residence, to identify one or more participating dealers who are conveniently located nearby (or alternatively, to identify all dealers so that any consumer-chosen dealer who has not yet been authorized to participate, but who also, upon prompting by a consumer request, may wish to become a participating dealer to serve the requesting consumer and others).

Utilizing another step taught by the present invention, the actual consumer purchase of a vehicle that the consumer selected from a listing of vehicles offered for sale to dealers only by a dealer-only wholesale vehicle auction, may then be accomplished through the selected participating dealer by the means of a purchase order from consumer to participating dealer. Such a purchase order agreement may include the description of the vehicle selected, a substitution provision for one or more alternate vehicles in the event that the dealer is unable to acquire the selected vehicle within the bounds of the purchase order agreement, purchase price, purchase terms including, among other things, establishment of deposits, inspection of the vehicle, potential rejection of the vehicle upon receipt or inspection by the consumer, acceptance of the vehicle, delivery of the vehicle to the consumer and transfer of title to the consumer.

Once the purchase order agreement between the consumer and the participating dealer is finalized, the participating dealer may then attempt to acquire the vehicle from the collective inventory offered for sale through a dealer-only wholesale vehicle auction. As employed herein, the term “auction” will be understood to encompass any organization or organized effort endeavoring to facilitate and/or intermediate sales of pre-owned vehicles exclusively to vehicle dealers by any known process and most often by the implementation of some type of competitive bidding. Rights to bid for vehicles from the collective inventory offered at an auction, may be restricted to licensed vehicle dealers who the auction has approved as authorized to bid.

The consumer's purchase price of a vehicle may be set in several ways. The consumer and participating dealer may agree on a fixed price. This price may be modified by an agreement to add to the fixed price, certain additional costs which may not be precisely determined in advance. It would also be possible to set a defined price based on a profit margin to be added to the amount paid for the vehicle by the selected participating dealer at auction, which may be any price up to a pre-agreed limit. In the latter case, the exact final price to the consumer may not be determined until after the vehicle has been acquired by the selected participating dealer at the auction.

Where the final negotiated selling price to the consumer is predicated on adding a sum to a successful bid by the participating dealer at auction, and where the successful bid may fall within a range of amounts, the final selling price to the consumer, where the successful bid is less than the maximum which was authorized, would be less than the pre-agreed maximum selling price. In this example, should the successful bid be less than the maximum bid, the difference between the successful bid and the maximum bid would be a savings that would be passed on to the consumer. Alternatively, the purchase order agreement could specify that any such savings would be divided in some manner between the participating dealer and the consumer such that the maximum selling price will be reduced by an agreed upon portion of the amount of the difference between the successful bid and the maximum bid.

Should the participating dealer be successful in the bidding process, the participating dealer may then arrange for transportation of the purchased vehicle for eventual inspection by and delivery to the consumer.

It is contemplated that the purchase order agreement may include a provision for the inspection and/or test driving by the participating dealer who submitted the successful bid and/or by the consumer as a condition precedent to final acceptance and consummation of the purchase by the consumer.

In that case the consumer would have the right to reject the vehicle and cancel the purchase. Upon any such rejection, the participating dealer may return the vehicle to the auction and either attempt to cancel the purchase made at auction if warranted by the reason for rejection, or otherwise to resell it in a future auction sale. Alternatively, the participating dealer may choose to retain the vehicle in physical inventory for retail sale to a different consumer.

Otherwise, the sale may be consummated by completing the terms of the purchase order agreement.

Although it is preferred to present the available inventory in a single aggregation, it is not critical to the invention that presentation be so limited. For example, alternatively, the consumer may be afforded access separately to a multitude of various different or unrelated auctions or other vehicle acquisition venues. In this manner, the concept of providing consumer access to those vast amounts of pre-owned vehicle inventory, which under the prior art has been systematically inaccessible to consumers, could still be accomplished even without aggregation, despite the additional efforts that would be associated with separately accessing various venues with disparate procedures.

In states where allowed by law, a non-refundable deposit may be agreed upon to cover the costs accruing to the participating dealer as the result of making a successful bid at auction, transporting and taking possession of a vehicle. This may come into play for example where the consumer fails to complete the sale. Alternatively, the deposit could be refundable or partially refundable under certain conditions and non-refundable under other conditions, all pursuant to terms specified in the purchase order contract.

A significant aspect of the invention is that administration of the novel system may be performed by a business entity which is not itself a dealer-only wholesale vehicle auction or participating dealer, but rather serves as the aggregator of the auction listings and/or acts as a facilitator which brings together many widely dispersed participating dealers and consumers. Other functions which may be undertaken by an administering business entity include for example arranging for and overseeing websites and similar display venues for presenting vehicle inventory compilations and/or aggregations to vehicle dealers and/or consumers, authorizing participating dealers and providing administrative services to auctions.

Referring now to the Figure, the invention may be defined as comprising a system and method 100 of distribution and sales of pre-owned vehicles. The method 100 may comprise a step 102 of establishing at least one authorized participating dealer engaged in the business of selling pre-owned vehicles to consumers; a step 104 of providing at least one wholesale vehicle auction for facilitating the sales of pre-owned vehicles exclusively to vehicle dealers including the participating dealer; a step 106 of establishing a compilation of at least one inventory of a plurality of pre-owned vehicles which are being offered for sale by at least one wholesale vehicle auction. The compilation may comprise plural inventories of plural wholesale vehicle auctions.

The method 100 may comprise a step 108 of making at least one pre-owned vehicle from the compilation available for purchase by vehicle dealers including participating dealers, through that auction; a step 110 of conducting the auction by taking bids from at least one of the dealers for at least one vehicle from the vehicles of the compilation; and a step 112 of transferring ultimate ownership of a vehicle purchased by a participating dealer through the auction, to the consumer. Of course, ownership will generally be required to pass first to the purchasing participating dealer, and then from the purchasing participating dealer to the consumer.

The method 100 may comprise a step 114 of making a purchase order agreement between one consumer and a participating dealer for the consumer's purchase of at least one selected vehicle that is a member of the compilation. The obligation of the dealer who makes the purchase order agreement with the consumer may be conditioned upon that dealer acquiring possession and control of the selected vehicle through the wholesale vehicle auction subsequent to the entry of the consumer and dealer into the purchase order agreement. As employed herein, possession and control may signify actual acquisition of title, or alternatively may merely represent the right to control who is to receive actual title to the selected vehicle. The method 100 may therefore comprise a step 116 of having the dealer acquire possession and control of the selected vehicle from another dealer. The step 116 may comprise the further step 118 of having the dealer purchase the selected vehicle at the wholesale vehicle auction.

The purchasing dealer may pay the auction the amount of the winning bid (plus any buyer's fees), and the consumer may pay the dealer the amount agreed upon in the consumer's purchase order given to the dealer for that vehicle.

The method 100 may optionally comprise a step 120 of limiting participation of buyers in the auction to licensed and/or otherwise authorized vehicle dealers.

The method 100 may comprise a step 122 of displaying listings, descriptions, vehicle condition reports, vehicle history reports, images and/or any other relevant information regarding vehicles which are available for sale to dealers through wholesale vehicle auctions, directly to a potential consumer through a communications network. The step 122 may comprise a further step 124 of presenting an aggregation of inventories of plural wholesale vehicle auctions for viewing by potential consumers at a single site via a communications network. The step 124 may comprise the further step 126 of presenting the aggregation of inventories to potential consumers over the internet, although of course other venues are possible.

The method 100 may comprise a further step 128 of arranging between one consumer and one participating dealer a predetermined price formula for the sale to the one consumer of the one specific vehicle, pursuant to a purchase order agreement which provides that the participating dealer will attempt to purchase the selected vehicle and upon successfully acquiring the vehicle, the consumer will pay the participating dealer a final consumer selling price based on the predetermined formula provided in the purchase order agreement, and the participating dealer will then cause the transfer of ownership of the selected vehicle to the consumer.

The method 100 may comprise a step 130 wherein the predetermined selling price from the participating dealer to the consumer is determined by adding a defined dollar amount to the amount of a winning bid submitted in the auction by the participating dealer, with the exact amount of the winning bid by the participating dealer not being known until after the participating dealer has successfully acquired the selected vehicle at auction.

The method 100 may comprise a step 132 wherein the purchase order agreement provides that the participating dealer will when bidding be limited to pay no more than a predetermined maximum dealer purchase price, and should the participating dealer acquire the selected vehicle at a price which is less than the maximum dealer purchase price established by the limit, the difference between the actual price paid by the participating dealer and the predetermined maximum dealer purchase price will be divided according to a predetermined division between the participating dealer and the consumer as established in the purchase order agreement such that the selling price from the participating dealer to the consumer will be reduced by the amount resulting from the division of the difference.

The method 100 may comprise a further step 134 of transferring title of a vehicle being transferred to a consumer directly from that dealer or lender who had offered the vehicle for sale through the auction, such that the participating dealer who entered into the purchase order agreement with the consumer and submitted the successful bid assumes the role of a broker in that particular transaction or sale of the vehicle.

The method 100 may comprise a further step 136 wherein the participating dealer with whom a consumer negotiated a purchase order agreement, includes as part of that agreement, the service of arranging physical delivery of the vehicle to that consumer who has acquired the vehicle.

The method 100 may comprise a further step 138 of requiring a minimum bid wherein the auction is conducted with a stipulation of a minimum bid for a vehicle being auctioned that must be met for a sale to be effected.

The method 100 may comprise a further step 140 which includes an arrangement wherein the consumer initially pays a non-refundable deposit to the participating dealer, ownership of which passes to the participating dealer in the event that the consumer fails to perform his or her duties under the purchase order agreement, including the failure to pay the agreed upon purchase price to the participating dealer to consummate the consumer's agreed upon purchase of the vehicle.

The method 100 may comprise a further step 142 of including an arrangement to place in escrow monies paid by a consumer to a participating dealer as part of an agreement to purchase a vehicle from a participating dealer who will then bid for the vehicle(s) which are desired by the consumer and available for sale to dealers through a wholesale vehicle auction.

The method 100 may comprise a step 144 of consummating the sale of the selected vehicle to the consumer after the possession rights to the selected vehicle have been acquired by the participating dealer who entered into the purchase order agreement with the consumer, directly from another dealer who had the selected vehicle in inventory.

The method 100 may comprise a further step 146 of including a participating dealer selection facility wherein a consumer may select a participating dealer by designating a zip code.

The method 100 may comprise a further step 148 of having the consumer inspect and/or examine the vehicle after its delivery to the participating dealer upon the participating dealer's acquisition, and subsequently accepting the vehicle, and paying the participating dealer the purchase price pursuant to the purchase order agreement.

The method 100 may comprise a further step 150 of having the consumer inspect or examine the vehicle, or both inspect and examine the vehicle, after delivery to the participating dealer upon the dealer having acquired the vehicle, and to subsequently decline to accept the vehicle in the event that the vehicle fails the inspection, the examination, or both. While a sale may fail to occur, this step may increase consumer confidence in the overall system.

The method 100 may comprise a further step 154 of causing the declined vehicle to be retained by that participating dealer who had acquired the vehicle at auction for the intended resale to the consumer pursuant to the purchase order agreement.

Any of the steps shown above may be practiced with or without any other step where that is feasible.

The steps of the method may vary from the order presented herein.

The term “at least one” will be understood to encompass both one and also more than one.

Accordingly, the present invention clearly and efficiently overcomes the many limitations associated with the prior art, and thereby represents a substantial improvement and a significant new step forward in the art. Provided below are two examples of the present invention which incorporate and utilize the steps provided above in two situations. The examples are not intended to be limiting in anyway, but instead enable those skilled in the art to practice the invention without undo experimentation.

### Example I

The first example provides for the use of a computer or other electronic device to access an independent third party website on the World Wide Web to aggregate and display (but not sell) direct to retail consumer vehicle buyers, all of the pre-owned vehicle inventory currently listed by participating dealer-only wholesale vehicle auctions worldwide. Using this preferred embodiment, consumers access the largest pool of pre-owned vehicles offered for wholesale purchase by dealers, to search for and select a vehicle that they desire to own, with all the convenience associated with shopping via the internet.

After viewing the aggregated auction inventory and selecting a vehicle for purchase, the prospective consumer vehicle purchasers then place a purchase order with a participating dealer of their choosing, who is or will become authorized to buy through that particular auction included in the aggregation which had listed the selected vehicle.

Then, upon receipt of a consumer's purchase order, the chosen participating dealer bids for the purchase of the selected vehicle(s) ordered by the consumer in the auction that has listed the vehicle for sale, either physically and/or online, within the parameters of the authority granted in the consumer's purchase order, including the maximum price the consumer is willing to pay the participating dealer for the vehicle ordered. The foreknowledge of such parameters by the participating dealer prior to purchasing the vehicle enables the participating dealer to calculate the maximum bid amount that will leave the minimum profit margin the participating dealer is willing to accept on the transaction.

Rather than allowing the dealer to keep the entire margin between the dealer's acquisition cost and the consumer's maximum purchase price, to better align the interests of the dealer with those of the consumer, this preferred embodiment calls for the dealer and consumer to specify in the consumer's purchase order, on a pre-agreed amount for the dealer's profit in terms of a fixed dollar amount and/or a percentage of the dealer's wholesale acquisition cost, to be added to the dealer's wholesale acquisition cost to provide the dealer with a reasonable profit for the service provided.

The intended and expected result of practicing this preferred embodiment is that the consumer gets a vehicle which truly meets the consumers purchase criteria, in a more transparent transaction, at a reduced retail price, by pre-ordering the vehicle and thereby eliminating the dealer's need for high mark-ups to cover the dealer's additional risks and costs associated with buying and carrying inventory on the “speculation” that a buyer will hopefully soon materialize. While the consumer enjoys a savings, if the dealer simply sells at a price that equates to the dealers average profit (which is significantly less than the dealer's per unit target profit due to reductions in the average profit from inventory losses and carrying costs), then the dealer will have succeeded in building volume and goodwill by giving a consumer an advantageous price, yet without reducing the dealer's profits, just by practicing the present invention with its new higher levels of efficiency. Further, beyond the purchase price savings alone, by practicing the present invention consumers would benefit from this new means by which to avoid most of the unnecessary waste of time, energy and expense associated with using the prior art method of looking for the desired vehicle by viewing the inventory of many different dealers, one at a time.

The steps to practicing this first example of the invention include:

Step One—Aggregation of dealer-only wholesale vehicle listings from a plurality of vehicle auctions. The vehicles listed in such aggregation would include all those vehicles currently available and/or anticipated to soon become available for bidding by vehicle dealers who are registered with and/or otherwise authorized to buy from and/or through, the various auctions included in the aggregation. Such vehicle listings are anticipated to include any available descriptive data in digital form, which may include the year, make, model, odometer mileage (or usage hours), vehicle identification numbers, vehicle condition reports, vehicle history reports, any other disclosures and photographic images associated with the vehicle.

Step Two—Viewing by a consumer, of the aggregation of auction vehicle listings.

Step Three—Selection by consumer, of a vehicle meeting consumer's desired criteria.

Step Four—Selection by consumer of a participating vehicle dealer who has and/or is able to obtain the authority to purchase vehicles from and/or through the particular dealer-only vehicle auction(s) that listed the selected vehicle(s).

Step Five—Executing of a purchase order by a consumer for the purchase of a selected vehicle from a participating dealer, and acceptance of such order by such dealer. Such purchase order could include provisions to address any conceivable possible scenarios and outcomes, including but not limited to, such considerations as: vehicle(s) selected, substitution, price, terms, deposits, condition, inspection, rejection, acceptance and delivery.

Step Six—Bidding by the dealer for the purchase of the auction listed vehicle(s) as described within the parameters of the consumer's purchase order.

Step Seven—Purchasing of the vehicle(s) by dealer for which the dealer's bid was accepted as the winning bid.

Step Eight—Transportation of the purchased vehicle by dealer or agent to dealer's location, or with consent of dealer, to a location selected by the ordering consumer.

Step Nine—Inspection and/or test driving of the dealer purchased vehicle by dealer and/or by the ordering consumer.

Step Ten—Acceptance of the vehicle by consumer as meeting the parameters of the purchase order or any other parameters acceptable to consumer, or rejection of the vehicle by consumer for its failure to meet the parameters of the purchase order.

Step Eleven—Consummation of the sale and delivery of accepted vehicle, to consumer, by dealer, as provided in the purchase order.

### Example II

A second example, which would likely be most useful in the event that the one central point of aggregation of auction listings as anticipated in the first example is for any reason unavailable in general and/or unavailable to consumers, instead utilizes the next most convenient means of consumer access to pre-owned vehicle inventory available for purchase by dealers nationwide. That is, to provide consumer access to view such inventory by viewing it through the use of a dealer's access to auction listings, in aggregate if any such aggregation is available to dealers, or otherwise by separately accessing listings from disparate auction venues, through the use of a computing device in possession of a dealer or by any means enabling remote access by a consumer utilizing a dealer's access to such auction listings. All other steps to practice this second example would be anticipated to be the same as Step Three through Step Eleven as described in the first example above.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method of selling pre-owned vehicles by a dealer of vehicles to a consumer, comprising the steps of:
establishing a compilation of at least one inventory of pre-owned vehicles which are available for wholesale sale to vehicle dealers through at least one dealer-only vehicle auction;
making the compilation of pre-owned vehicle inventory available for viewing by consumers;
making a purchase order agreement between one consumer and one dealer for the consumer's purchase of at least one selected vehicle which is a member of the compilation of inventory of pre-owned vehicles and which is available for viewing, wherein the obligation of the dealer to sell to the consumer is conditioned upon the dealer acquiring ownership, possession or control of the selected vehicle through a the dealer-only vehicle auction subsequent to the entry of the consumer and the dealer into the purchase order agreement;
having the dealer acquire ownership, possession or control of the selected vehicle through the dealer-only vehicle auction; and,
consumating the sale of the selected vehicle to the consumer after the ownership, possession or control of the selected vehicle has been acquired by the dealer through the dealer-only vehicle auction, including payment from the consumer to the dealer of the agreed upon price pursuant to the purchase order agreement, delivery of possession of the vehicle to the consumer, and delivery or transfer of the title to the vehicle to the consumer.

2. The method of claim 1, wherein the step of having the dealer acquire ownership, possession or control comprises the further step of having the dealer purchase the selected vehicle through a dealer-only vehicle auction.

3. The method of claim 2, comprising the further step of limiting participation in the auction to licensed and/or authorized dealers.

4. The method of claim 1, wherein the step of making the pre-owned vehicles of the compilation available for viewing by consumers comprises the further step of displaying any manner of descriptive information including images associated with the vehicles in inventory to consumers through a communications network.

5. The method of claim 1, comprising the further step of presenting an aggregation of inventories of plural dealer-only vehicle auctions for viewing by consumers at a single site via a communications network.

6. The method of claim 5, comprising the further step of presenting the aggregation of vehicle inventories to consumers over the internet.

7. The method of claim 1, comprising the further step of arranging between one consumer and one dealer a predetermined price formula which will result in a final price to be paid by the one consumer to the one dealer for the selected vehicle, with the agreement that the one dealer will attempt to acquire the selected vehicle and upon successfully acquiring the vehicle, the one consumer will pay the final price based on the predetermined formula to the one dealer who has successfully acquired the selected vehicle, and the one dealer will cause the transfer of ownership of the selected vehicle to the one consumer.

8. The method of claim 7, wherein the selected vehicle is available through a dealer-only vehicle auction, and the negotiated price is determined by adding a defined dollar amount to a winning bid submitted by the one dealer in the course of the auction, with the exact amount of the winning bid paid by the one dealer not being known until after the one dealer has successfully acquired the selected vehicle at auction.

9. The method of claim 8, further comprising a purchase order agreement which provides that the dealer will be limited to pay no more than a pre-determined maximum dealer purchase price, and should the dealer be successful in acquiring the selected vehicle at a price which is less than the maximum dealer purchase price, the difference between the actual price paid by the dealer and the maximum dealer purchase price pre-determined in the purchase order agreement will be divided according to a predetermined division between the dealer and consumer as established in the purchase order agreement such that the selling price from the dealer to the consumer will be reduced by the amount resulting from the division of the difference.

10. The method of claim 1, comprising the further step of causing the selected vehicle to be physically delivered to the consumer as part of the transaction defined by the purchase order agreement.

11. The method of claim 1, including an arrangement wherein the consumer pays a deposit to the dealer in conjunction with the purchase order agreement with predetermined conditions which may or may not provide for the return of at least part of the said deposit.

12. The method of claim 1, further including an arrangement to place in escrow monies paid by the consumer to the dealer in conjunction with the purchase order agreement, wherein the arrangement to place in escrow monies paid by the consumer includes instructions governing disbursement of the said monies placed in escrow.

13. The method of claim 1, further comprising a participating dealer selection facility wherein a consumer may select the dealer from a plurality of potential dealers by designating a zip code.

14. The method of claim 1, wherein the consumer physically inspects the selected vehicle prior to completion of consumer's purchase of the selected vehicle, and the consumer thereafter accepts the selected vehicle and completes the purchase by paying the purchase price to the dealer pursuant to the purchase order agreement.

15. The method of claim 1, wherein the consumer physically inspects the selected vehicle prior to completion of consumer's purchase of the selected vehicle, and the consumer thereafter rejects the selected vehicle as a consequence of the inspection, and does not complete the purchase of the selected vehicle.

16. The method of claim 1, comprising a further step of transferring title of a vehicle being transferred to a consumer directly from that dealer or lender who had offered the vehicle for sale through the auction, such that the participating dealer who submitted the successful bid assumes the role of a broker in that particular transaction or sale of the vehicle.

17. The method of claim 1, wherein the purchase order agreement includes as part of that agreement the service of arranging physical delivery to that consumer of the vehicle which has been acquired by that consumer.

18. The method of claim 1, wherein the first two steps of the method are administered by a business entity which is not itself a dealer or an auction.

19. The method of claim 1, comprising the further step of having the dealer retain the selected vehicle in the event of rejection by the consumer.

20. The method of claim 1, comprising the further step of including an arrangement wherein the consumer initially pays a deposit to the dealer, ownership of which passes to the dealer in the event that the consumer fails to perform his or her duties under the purchase order agreement, including the failure to pay the agreed upon purchase price to the dealer to consummate the consumer's agreed upon purchase of the selected vehicle.

21. The method of claim 5, wherein the method is administered by a business entity which is not itself a dealer or an auction.
